(19) United States
(12) Patent Application Publication
(10) Pub. No.: US 2008/0033818 A1
(43) Pub. Date: Feb. 7, 2008

(54) Real time interactive response system and methods

(75) Inventor: Millo Avissar, Jerusalem (IL)

Correspondence Address: GOODWIN PROCTER L.L.P, 599 LEXINGTON AVE., NEW YORK, NY, 10022, US

(73) Assignee: Inc2 Webcom Ltd., Jerusalem (IL)

(21) Appl. No.: 11/824,727

(22) Filed: Jul. 2, 2007

Related U.S. Application Data
(63) Continuation-in-part of application No. 11/372,407, filed on Mar. 8, 2006.
(60) Provisional application No. 60/662,743, filed on Mar. 17, 2005.

(51) Int. Cl. G06Q 30/00

(52) U.S. Cl. 705/14

(57) ABSTRACT

A system and method is disclosed in which advertisers actively look for potential consumers by capturing network activity. A User Activity Outline (UAO) is formed by populating a data structure with captured and other information relating to the user activity. The system identifies and informs one or more relevant providers/advertisers in real time about the user activity using a Prompt Sales Lead Notification (PSLN). A relevant advertiser can respond (or not) to the PSLN by transmitting a message, an advertiser prompt proposal (APP), in real time to the system. The system creates Enhanced APP (EAPP) for each APP selected for presentation, and/or Combined EAPP (CEAPP). Methods of presentation include visual, audio, or a combination of both, and include setting a waiting period for presentation. The ads' relevance can be visually and/or audibly indicated. The ads can be prioritized for presentation by the system and at set intervals of time.

### CROSS-REFERENCE OF RELATED APPLICATIONS

This application is a continuation-in-part application of, and claims the benefit of priority to, pending U.S. Ser. No. 11/327,407, filed Mar. 6, 2006, which claims the benefit of priority to U.S. Provisional Application No. 60/662,743, filed on Mar. 17, 2005, the entire disclosures of which are both hereby incorporated by reference as if set forth at length herein.

### BACKGROUND OF THE INVENTION

In a traditional advertising directory paradigm, only potential consumers are actively looking for something (potential providers), while potential providers (advertisers) are passive, after they place their advertisements. There is a need for a system and method which enables advertisers to actively look for something (potential consumers) and possibly present advertisements tailored to a found potential consumer.

### BRIEF DESCRIPTION OF THE INVENTION

In accordance with the system and method, of this invention advertisers actively look for something (potential consumers).

This is done by equipment connected to a network capturing information relating to a computer users (potential consumers) network activity. An activity can be composed of a single or multiple user actions. In some instances the users initiates a search and in other instances certain other activities of the users are interpreted as an indication that he/she is a potential consumer. The activity can be any type of user action that can be identified and/or interpreted as the user being a potential direct or indirect sales lead.

A User Activity Outline (UAO) is formed for the computer user's by populating as many data elements as possible in a data structure with the captured information and other information relating thereto. This other information may be collected from many possible sources. The information can be check for validity and/or edited based on rules and/or the information from the other sources.

Next, the system identifies and informs a relevant provider or advertisers in real time about the user and his/her activity. This can be called a Prompt Sales Lead Notification (PSLN). The notification can be done on the network or by some other means.

If a relevant advertiser decides to respond to the PSLN, he/she can do so by transmitting a message in real time to the system. If the system receives more than one massage in response to a particular UAO the system may, in one embodiment, screen the messages and/or information about the advertiser to establish priorities between the advertisers for purposes of further notification and/or priority of presentation. In any event the system contacts the user providing an advertisement and/or other information relating to one or more of the responding advertisers. The response need not be on the network.

One or more of the ads and/or other information relating to the relevant advertiser or advertisers can be presented, in real time, to the potential customer. A waiting period may be set between the time the system server receives the ads from relevant advertisers and the time the ads are presented. The waiting period can be calculated, for example, by employing data from the captured information, or from a date and time of occurrence of the potential customer's activity. It can also be calculated from parameters associated with the performance of the system server including load, performance, and/or priorities.

Optionally, the potential customer can set a predefined minimum number of ads for display, or stop the presentations in real-time, for example, by clicking on a button on a graphical user interface presented on the potential customer's computer, by sending a manual request to the system server or directly to the relevant advertisers, or by providing a voice command to the relevant advertisers. A group of ads can also be determined for display according to a pre-set quota, and a new group of ads displayed each time the quota is reached.

Additionally, the system server can analyze the ads and/or other information relating to the relevant advertisers, information from the computer readable medium, and the captured information in order to prioritize the sequence of presentation of the ads to the user. The analysis can include any combination of the following: time of creation, content, cost of presenting, relevancy to the captured information, history of each of the one or more relevant advertisers, a preference of each of the one or more relevant advertisers, and a preference of the potential customer.

The ads and other information can be displayed as on-going visual media content. The on-going visual media content includes any combination of: a graphic icon, a picture, a video clip, a snapshot of a website, descriptive text providing information about the relevant advertiser, a URL, a communication button providing a link to an internet communication service, a personalized response, and a visual indicator of a degree of relevance of the ad to the captured information.

The descriptive text includes one or more of: the name of the one or more of the relevant advertisers, a corresponding business name, a corresponding business category, a promotional description, an address, directions, a map, references and consumer feedback. The URL can include an internet link to a website, a coupon, a map, a satellite image, a video, and/or a webcam. The internet communication service can include Instant Messenger, a call service and/or a chat service accessible by clicking the communication button.

The ads can optionally or additionally be presented in audible form. The audible form can include any combination of the following: voice messages, sound effects, a personalized voice response, and an audible indicator of a degree of relevance of the ad to the captured information. One or more of the voice messages can include the name of the relevant advertisers, a corresponding business name, a corresponding business category, a promotional description, an address, directions to the address, or consumer feedback.

The user may respond to the advertisement and/or other information by indicating which of the advertisers he/she wishes contact with.

At this point in the method there are many alternative options available. In one embodiment the system can be an intermediary to the contact or in another embodiment the system can help establish a direct contact.

The advertisers can be charged upon one or several of the following events:

1. Display of an opportunity to the advertisers

2. Sending of advertiser's response to the user

3. Advertiser's selection by the user

4. Advertiser's deal closure with the user

5. Advertiser's receiving a payment from the user

### DESCRIPTION OF THE DRAWINGS

The present invention can be better understood from the Detailed Description of the Invention, taken in conjunction with the following drawings. It should be apparent to those skilled in the art that the described embodiments of the present invention provided herein are merely exemplary and illustrative and not limiting. All features disclosed in the description may be replaced by alternative features serving the same or similar purpose, unless expressly stated otherwise. Therefore, numerous other embodiments of the modifications thereof are contemplated as falling within the scope of the present invention and equivalents thereto.

FIG. 1 is a block diagram of a system which can perform a method in accordance with one or more embodiments of this invention.

FIG. 2 is a flow chart of Step 1 of a method in accordance with one embodiment of this invention.

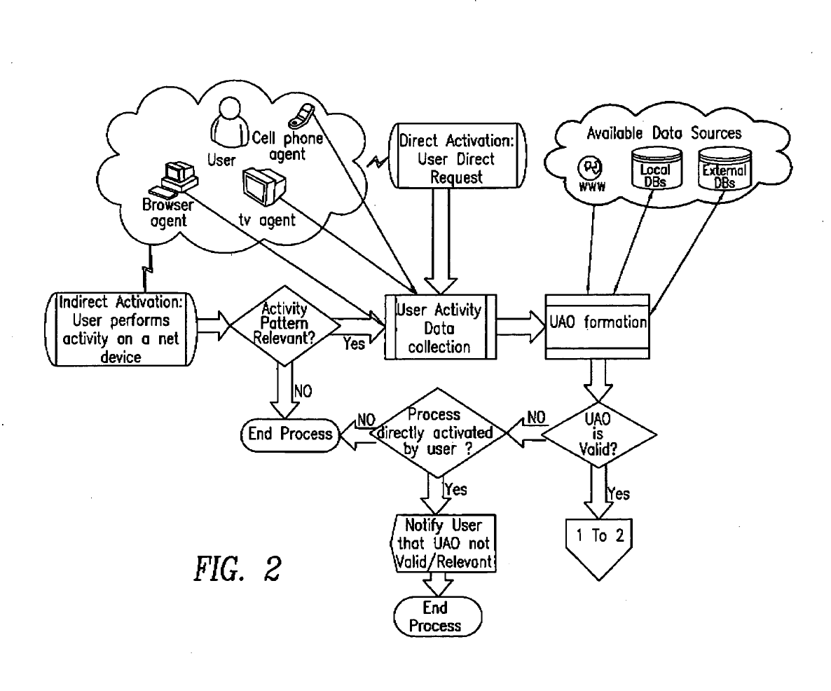

FIG. 3 is a flow chart of Step 2 of a method in accordance with one embodiment of this invention.

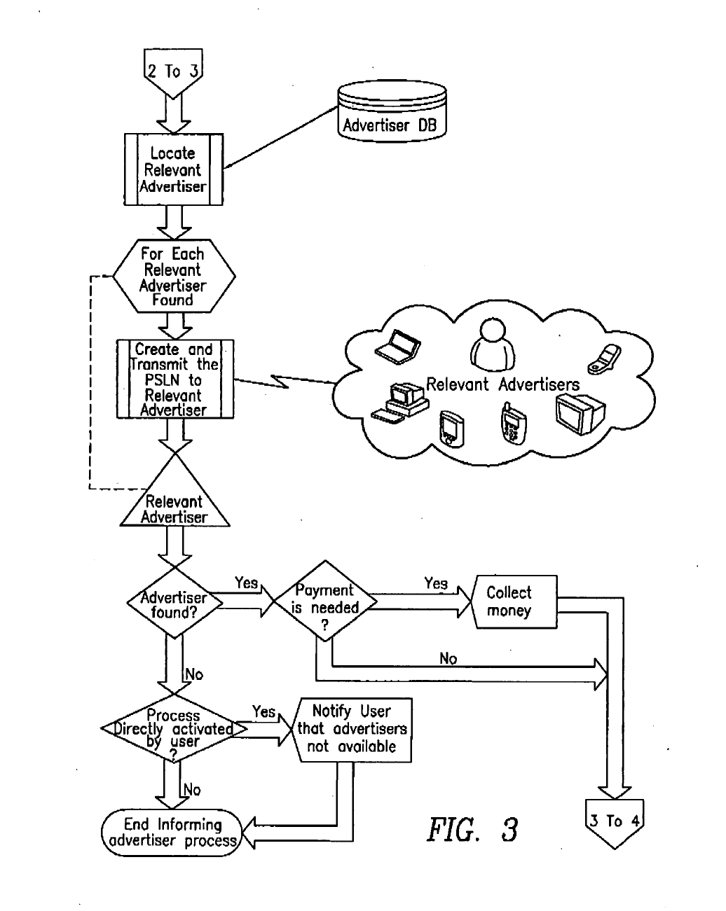

FIG. 4 is a flow chart of Step 3 of a method in accordance with one embodiment of this invention.

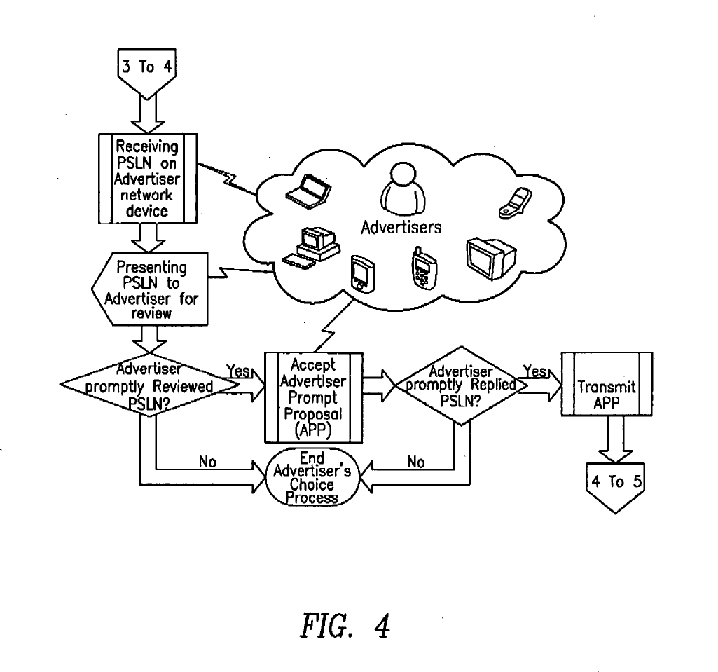

FIG. 5 is a flow chart of Step 4 of a method in accordance with one embodiment of this invention.

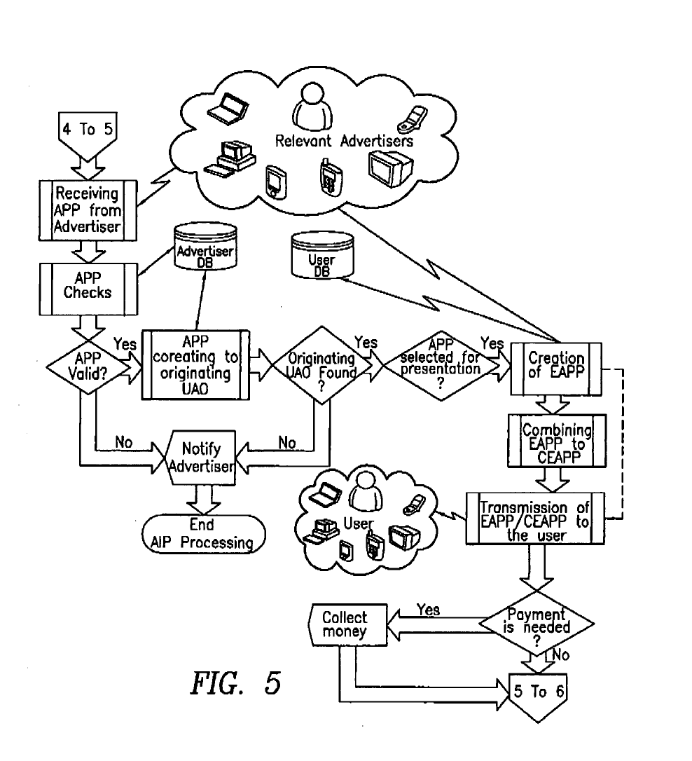

FIG. 6 is a flow chart of Step 5 of a method in accordance with one embodiment of this invention.

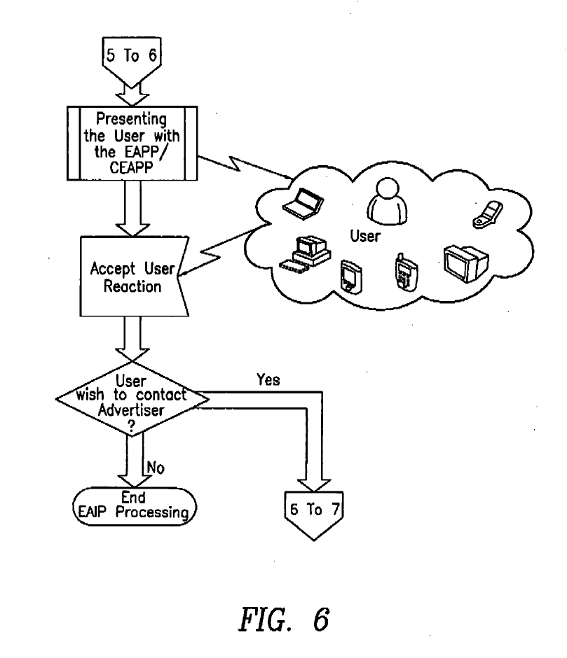

FIG. 7 is a flow chart of Step 6 of a method in accordance with one embodiment of this invention.

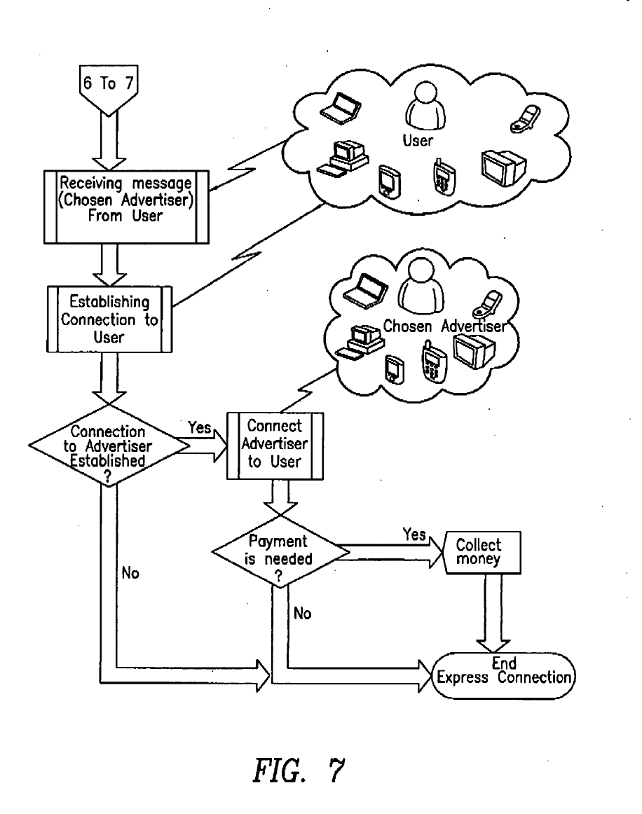

### DETAILED DESCRIPTION OF THE INVENTION

The system and method provide a business opportunity to registered service and/or product providers (advertisers) by informing one or more of the registered advertisers in real time upon the occurrence of an activity initiated by a user (potential consumer) indicating the need for their service/products, and allows the advertisers in real time to contact, interact and/or communicate with the user.

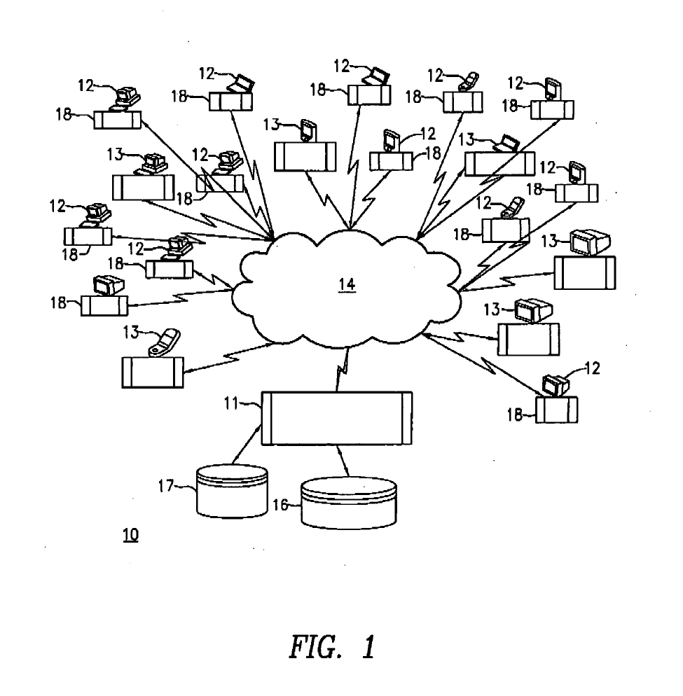

The system 10, see FIG. 1, includes a system server 11, a plurality of user terminals (devices) 12, a plurality of advertiser terminals 13 and a network 14 through which each of the above can communicate.

Prior to a service and/or product provider participation in the system 10, the provider is registered as an advertiser and information relevant to it is entered in an advertiser database 16 which is on or associated with the system server 11. The information can include payment terms between the advertiser and the owner of the system.

The advertiser database 16 is an integral part of the system and method and may include some or all of the following information: advertiser identification, authentication, contact information, services provided, preferred opportunities and payment information (prepaid or postpaid).

Users can provide information relevant to them which can be stored in a user database 17 for registered users. Information for transient one-time users may not be stored in the data base.

A user can access the system 10 through any suitable device 12 some of which are listed below. Any device for accessing the system server 11 is included in the term computer as used herein. Such devices include:
1. A terminal device for access to the network 14, such as the internet. Such terminals include a PC/Laptop. These terminals can use a web browser, net application, button on a toolbar or other application.
2. Mobile device such as mobile telephone, PDA, etc. These devices can use SMS request, WAP or web browser
3. TV (set top box)
4. Telephone

Depending on the technology and architecture on which the system 10 is implemented:
Process initiation can be accomplished by modules which reside at one or more network locations to identify and capture user activities. Such modules are referred to herein as “network activity monitoring modules.” Such locations can be:
   Directory net site (can be a web site or a telephone terminal)
   Search Engine net server
   Electronic bulletin board
   User net device 12

Such network activity monitoring modules for on-line profiling of consumers is well-known to those of skill in the art. For example, “cookies” placed on consumer's computer, other devices, and on net sites, can track Internet users.

The application and software modules for implementing the method of the present invention, unless indicated otherwise, reside on the system server 11. The system 10 also includes computer readable media (not shown) for storing information, such as the advertiser database 16, the User Activity Outlines and information associated therewith, and the ads received from registered advertisers fro presenting to a potential customer. Preferably, at least one computer readable media is on the server. The computer readable media can include any suitable media for receiving and storing data with read access, and the same media can be used to store all of the information gathered for implementation by the system. Alternatively, or additionally, different media can be used for long-term storage of part or all information and data generated, including the registered advertiser's database, than that for the temporary storage of ads selected for presentation to the user. In the former case, standard hard drive and the like can be used. For the latter, it may be preferable to use non-volatile or volatile memory for the temporary storage of ads, once submitted by advertisers and selected for presentation to the potential customer.

The system 10 and method can be considered as a modified interactive electronic market paradigm. While in a traditional electronic market paradigm, only the potential consumers are actively looking for something (potential providers), while users are passive, after they place their advertisements. In this system and method, the providers are enabled to actively look for something (potential consumers). In some instances, the user initiates a search for a particular item which is considered a direct lead and in other instances, certain activities of a user are interpreted as an indication that he/she is a potential consumer and constitute an indirect lead.

The activity can be any type of user action that can be identified and/or interpreted as a potential direct or indirect sales lead.

For example—An online search for a specific product or service indicates and provides a clear sales lead. The search can be done using any of the known search services such as:
Search engine (such as MSN, Google, Yahoo), for both local and general search purposes.
General guided directory web site (such as superpages.com or smartpages.com).
Web site serving as a guided directory.

An example of a direct lead is:
User activates a search engine entering “Plumber Richmond Va.” as a search string
User accesses the 1st search results
User returns to the search list
User accesses 4th search result
User activates the search engine again looking for “Pipe Layer Richmond Va.”.

An indirect sales lead can be deduced from a variety of activities, such as:
The purchase of a product that requires supplemental products and services. For example, purchase of computer may serve as a sales lead for computer peripherals hardware suppliers, software product providers and computer technicians.
Information update such as change of physical address may indicate a person or a company has changed their location and provides an indirect sales lead to a variety of service provider such as gardeners, roofers, electricians, etc.
Advertising an apartment for sale on a digital real-estate buy-and-sell board may serve as an indirect sales lead to real-estate agents, movers and lawyers specializing in real-estate contracts.

An example of an indirect lead is:
User activates a search engine entering “Restaurant in New York” as a search string
User is identified as a foreign individual from the device used to access the search engine
System concludes that user is a visitor and can require certain goods and services visitors often purchase.

The registered advertiser can be charged upon one or several of the following events:
1. Upon display of opportunity to the registered advertiser
2. Upon advertiser's appearance on the user's displayed list
3. Upon advertiser's selection by the user.
4. Upon advertiser's deal closure with the user
5. Upon advertiser receiving a payment from the user
   Step 1—Process Initiation—See FIGS. 1& 2

Initiation of the system/method begins after a triggering event, received by the system server 11.

Triggering Event

The detection of certain data from a user device 12 at the system server 11 constitute a triggering event.

Main Functions (at System Server)

Process Activation
User Activity Data collection
User Activity Outline Formation
   Process Activation

When a user manipulates a user device 12 performing a particular activity, and data relating thereto is sensed at the system server 11 the system 10 can be activated in one of the following ways:
Direct User Activation—The data indicates that the network user is requesting the activation of the system 10 in various ways, including:
   accessing a specific network location (such as a web site or telephone terminal) and
   activating a specific application.

Indirect User Activation—This occurs when the data indicates that the network user is performing any kind of activity on a user device 12. The system identifies the user's actions on such user device 12 (such as computer, PDA, TV, mobile device, telephone, etc). Each action made by the user on the particular user device 12 is examined to identify a relevant activity pattern. Once a set of actions is identified as a relevant activity pattern (for example, activation of a search engine or accessing a Directory), the process continues.

User Activity Data Collection

In the next stage in process initiation, the system server 11 collects information to populate as many data elements as possible in the data structure called User Activity Outline (UAO). This information may be collected from many possible sources, such as:
the user device 12 used by the user which could provide, among other things, the location the user is performing the activity from;
a network server accessed by a user device 12; and/or
relevant internal and external data which can be from databases such as user database 17.

In some instances, an agent 18 or the like is provided on one or more user devices 12 or other data sources.

User Activity Outline Formation

This part of the process, described below, is part of any well designed network system but need not be included in a system in order for such system to be within the scope of this invention. It is included here for purposes of completeness.
UAO data element checks—The system may check the integrity and completeness of the relevant UAO data elements, for example:
Actual user activation—the system server 11 may verify it was not activated as a result of an automated process such as a computer virus.
Such integrity and completeness violations will result in defining the UAO as Invalid UAO.
If the UAO contains address data, the system server 11 may verify the address data provided constitutes a valid postal or physical address according to local rules (such as USPS standards).
Such integrity and completeness violations are not considered critical as it may not be relevant or may be completed or corrected as part of the UAO Edits.

If the system server 11 identified an invalid UAO, for example, a UAO that was created by an automated process (virus), there is no point in further processing the UAO:
If the invalid UAO was directly activated, the system server 11 will notify the particular user device 12 that the UAO was identified as invalid and the process will end.
If the invalid UAO was indirectly activated, the process will end.
UAO data Edits (analysis)—Using internal and external data sources, the system server 11 attempts to correct UAO data elements found to be invalid and complete missing UAO data elements that were not available or could not have been defined before such as:
Generation of Unique UAO ID
Address Data Correction
Relevant Provider Type Identification—Identifying of the types of provider that might be interested in such a type of user activity. For example—if the user is advertising an apartment for sale on a real-estate digital buy-and-sell board, real-estate agents, movers and lawyers specializing in real-estate contracts may be interested in a sales lead for this user.
Keywords text deduction done by a lexical analysis rule based program, for example, typo corrections.

Methods for authenticating and verifying data and for protecting computer systems from viruses are known to those of ordinary skill in the art. Many such virus-protection software programs are commercially available and may be integrated into the present system.

UAO formation—The system server 11 forms the UAO from all the data elements populated previously after corrections.

Output from Step 1

The server system 11 forms a UAO.

Step 2—Identifying and Informing Select Advertisers—See FIGS. 1& 3

Identify and inform relevant advertisers at advertiser terminals 13 about the relevant user activity at it's user device 12.

Activation

By Step 1 completion—receipt of a UAO

Main Functions (Also at System Server 11)

Locating Relevant Advertisers
Informing Relevant Advertisers
Charging Advertiser (optional function)
   Locating Relevant Advertisers

The system server 11 searches for relevant registered advertisers in the advertiser database 17. The advertiser database 17 may identify provider type, service type, advertiser's terminal 13 IP address and/or any other appropriate parameters.

If relevant advertisers can not be found in the advertiser database 11, the system server 11 will react as follows:
If the process was directly activated, the system server 11 will notify the relevant user device 12 and the process will end.
If the process was indirectly activated, the process will end.
   Informing Relevant Advertisers

When relevant advertisers are located, for each relevant advertiser, the system verifies that there is a way to promptly interact with the advertiser. The system creates and transmits a Prompt Sales Lead Notification (PSLN) to each of the relevant advertisers terminal 13 based on the UAO. The PSLN, in most cases will not include sufficient information to identify the originating user or his/her device 12.

The PSLN can be a voice message, RSS feed, SMS or any other message form technologically possible for prompt transmission. It may also be a Screen Display to a human operator who is promptly contacting the advertiser.

Charging Advertiser

Depending on the advertiser's registration agreement with the system owner, the system server 11 may charge the advertiser at this stage for the PSLN.

Output from Step 2

The output from Step 2 is a Prompt Sales Lead Notification (PSLN) to each relevant advertiser terminal 13. An optional charge to the advertiser's account (prepaid or postpaid) is made.

Step 3—Advertiser's Choice—See FIGS. 1 & 4

Step 3 includes enabling a relevant advertiser to promptly review the PSLN and choose to reply.

Activation

Advertiser Terminal 13 Receiving PSLN

Main Functions (at Advertiser Terminal 13)

PSLN Review by Advertiser
Advertiser Response
   PSLN Review by Advertiser

Upon receiving the PSLN, the relevant advertiser may choose to do at least one of the following:
Review the PSLN promptly.
Ignore the PSLN—If this is the advertiser's choice, the process is ended. As far as the method and system is considered, if the advertiser does not respond to the PSLN promptly, it is considered as if the PSLN was ignored or dismissed.
   Advertiser's Response

An advertiser may receive multiple PSLNs in the same time frame. If the advertiser decides to promptly review a specific PSLN, he or she may choose to use one of the following options:
reply to the PSLN promptly—if the advertiser decides to promptly reply to the PSLN, he/she can do so by transmitting Advertiser Prompt Proposal (APP) from his/her advertising terminal 13 to the system server 11; or
not reply to the PSLN. If this is the advertiser's choice, the process is ended.
   Output from Step 3

APP—Advertiser Prompt Proposal (APP) is sent back to the system server 11.

Step 4—Advertiser Prompt Proposal (APP) Processing and Transmitting—See FIGS. 1 & 5

Step 4 includes providing the user with responses from one or more relevant advertisers.

General

The system server 11 may receive multiple APPs that were a result of relevant advertisers' terminals 13 responding to the particular UAO. Each APP is processed as described below.

Activation

System Server 11 Receiving APP from advertiser terminal 13

Main Functions (at System Server)

APP Checks
APP correlating to originating UAO and or the PSLN
Comparison to other APP relating to the same originating UAO, if any. Determine if an APP is to be presented to the user and determine its priority in presentation.
If selected for presentation to user, creation of EAPP (Enhanced Advertiser Prompt Proposal)
Optionally combining selected EAPPs to provide a CEAPP (Combined Enhanced Advertiser Prompt Proposal)
Transmission of EAPP and/or CEAPP to the user device 12
Charging the advertiser (optional function)
   Advertiser Prompt Proposal (APP) Checks

The system server 11 receives the APP transmission and promptly checks the integrity and completeness of the APP. For example:
Actual advertiser activation (authentication)—the system verifies that the APP was received from an actual advertiser and not a result of an automated process such as computer virus.
Such integrity and completeness violations will result in defining the APP as an invalid APP.

If the system identified APP to be invalid, the processing of the APP ends.

Advertiser Prompt Proposal correlating to Originating UAO

In order to identify the user to which the APP is addressed, the system matches the APP to the originating UAO.

If the system is unable to match the APP to the originating UAO, the system may inform the advertiser at its advertiser terminal 13 that the PSLN is no longer relevant and the processing of the APP ends.

Comparison to Other APP

In some instances it is desired to select a reduced number of APP to be shown to the user. In order to do so the system server 11 will compare the APP to other APP's relating to the same originating UAO, if more than one has already been received. The system server 11 will determine if an APP is to be presented to the user and will determine its priority in presentation. The selection is based on the APP data as well as on information from other available data sources (such as Advertiser ratings by other users).

Creation of EAPP

The system server 11 creates the EAPP. The EAPP is based on the APP data as well as on information from other available data sources (such as Advertiser ratings by other users).

Combining Selected EAPPs to Create a CEAPP (Combined Enhanced Advertiser Prompt Proposal)

Optionally selected one or more EAPP can be combined to a CEAPP.

Transmission of EAPP and/or CEAPP to the User

The EAPP and/or CEAPP are transmitted to the relevant user device 12.

Charging Advertisers

Depending on the advertiser's registration agreement with the system owner, the system may charge the advertiser at this stage for transmitting the EAPP.

Output from Step 4

The EAPP or CEAPP is sent to the relevant user device 12. Optionally, a charge is made to the advertiser's account (prepaid or postpaid).

Step 5—User Review and Reaction to EAPP or CEAPP—See FIGS. 1 & 6

In Step 5, the user is presented with the EAPP or CEAPP for review and reaction.

In particular, the EAPP and/or CEAPP can be presented according to the following methods:

Methods of Presenting the EAPP and/or CEAPP

The system can present the EAPP and/or CEAPP after a period of time, referred to herein as a “waiting period,” that is system-defined, user-defined, or a combination of both. In one embodiment, the waiting period is set by the system's rule-based engine. The length of the waiting period can be predefined and/or calculated by the system in real-time. In the latter case, the waiting period is calculated according to a rule-based engine decision, taking into account one or more of the following data:
UAO;
date and time of the occurrence of the activity; and
system parameters such as hosting, load, performance and priorities.

In another embodiment, the waiting period is set by user preferences. For example, the system will display the EAPP and/or CEAPP after the user initiating the activity chooses to do so, by, for example:
setting a predefined time-frame for the waiting period;
setting a predefined minimum number of EAPP and/or CEAPP; or
stopping the process in real-time by informing the system of his will to present the EAPP and/or CEAPP promptly using one or more of the following methods:
   clicking on a button on a graphical user interface on the potential customer's computer, for example, in a waiting-for result page;
   sending a specific manual request using any network connected device; and/or
   providing a voice command to an IVR system and/or telephone representative.

Any appropriate method of and format for presenting the results of the EAPP and/or CEAPP are within the scope of the invention. In one embodiment, the system implements a visual method that includes displaying on-going visual media content of EAPP and/or CEAPP.

In another embodiment, a “per-quota” method includes providing a display of a group of EAPP and/or CEAPP at pre-determined periods of time and/or when pre-determined quotas of EAPP and/or CEAPP are met. In yet another embodiment, a visual method of presenting the results of the EAPP and/or CEAPP includes displaying all of the EAPP and/or CEAPP at once. Any one or more of these methods can be combined.

The system can additionally or alternatively implement an audio method of presenting the results of the EAPP and/or CEAPP. One audio method includes playing voice messages, and/or sound effects in an ongoing play mode of any EAPP and/or CEAPP upon their creation in the system. In another embodiment, a “per-quota” method includes play of a group of EAPP and/or CEAPP at pre-determined time intervals and/or for pre-determined quotas of EAPP and/or CEAPP created in the system. In yet another embodiment, the EAPP and/or CEAPP results are played for all the EAPP and/or CEAPP at once. Any one or more of these audio methods can be combined with each other and/or any one or more of the visual methods described above.

Different methods of ordering the EAPP and/or CEAPP for presentation are also within the scope of the invention. For example, the order of presented EAPP and/or CEAPP can be defined by one or more of the following:
time of EAPP and/or CEAPP creation;
content of EAPP and/or CEAPP;
potential cost of presenting EAPP and/or CEAPP;
relevancy of EAPP and/or CEAPP to UAO;
history of the advertiser;
preference of the advertiser; and/or
preference of the user.

Preferably, a list o FEAPP and/or CEAPP is created, which can be prioritized to establish a sequential order for the presentation of ads, or groups of ads, to the potential customer. When an ad is added to the list, the list can be extended and re-prioritized.

EAPP and/or CEAPP Content

Visual Content

The system can present a visual EAPP and/or CEAPP by showing one or more of the content:
Graphic Icon
Picture
Video clip
Snapshot of website
Advertiser description: a text in various formats, fonts and colors which provide information about the advertisers in the EAPP and/or CEAPP:
   The name of the advertiser
   The business name
   Business categories
   Address
   Promotional description
   Driving Instructions
   References
   Consumers' Feedbacks
URL—To a website, coupon, map, satellite image, video, webcam, driving instructions, etc.
Communication button—such as click-to-call, click-to-chat, Instant messenger, etc.
Personalized response—a response provided to the specific user in any of the ways described above. Such a response can be predefined or created by the target in an ad-hoc manner.
Relevancy to the UAO of the EAPP and/or CEAPP, this can be displayed in a textual or graphic manner and can be defined by an ad-hoc response or a calculation done by the system or a combination of both. Such content can mean for example:
   Most relevant
   Relevant
   Partially Relevant
   Not Relevant
      The degree of relevance, for example, can be indicated by increasing brightness levels from least to most relevant, or increasing size of text and images from least to most relevant, the largest, most prominent ads being the most relevant ones, or by the use of animation to grab the attention of the consumer to the more relevant ads. The degree of relevance could also be visually indicated by placement on a page, with most relevant ads being forward of less relevant ads and/or more centrally located on the page.
      Audio Content

The system can present an audio EAPP and/or CEAPP by sounding one or more of the following types of content:
indicating sound effects;
voice message including:
   the name of the advertiser,
   the business name,
   business category,
   a promotional description,
   address,
   driving instructions, and/or
   consumers' feedbacks;
personalized voice response—a response provided to the specific user in any of the ways described above (such a response can be predefined or created by the target in an ad-hoc manner); and/or
relevancy to UAO, this can be presented in a voice indicating sound effect and/or voice message and can be defined by an ad-hoc response or a calculation done by the system or a combination of both.
Such content can mean for example:
   Most relevant
   Relevant
   Partially Relevant
   Not Relevant
      The degree of relevance can be indicated, for example, by increasing volume for most relevant compared to lesser relevant ads, or by the use of different sound effects or voice messages as indicators of degree of relevance, or by the use of longevity of a particular sound to indicate a degree of relevance.
      Activation (at User Site)

Receiving EAPP or CEAPP

Main Functions

Presenting the user with the EAPP or CEAPP
User sending Reaction to EAPP or CEAPP, to the system server 11 and or to a particular advertiser.
   Presenting the User with the EAPP or CEAPP

If the user directly activated the system, the EAPP or CEAPP or a summary thereof is presented to the relevant user device 12.

If the system was indirectly activated, depending on the architecture of the relevant user's device 12, the system server 11 might first obtain user approval for presenting the EAPP or CEAPP or a summary thereof.

The presentation to the user device 12 may include options to request additional information. This information could be:
advertiser's reputation based on other users' review, qualifications and history of past performance;
additional advertising material including: text, image, video, voice message or any other media file; and/or
payment options for one or more advertisers.
   User Reaction

If the user is interested in further communication with the system server 11 or one or more advertisers, the system server 11 may be configured to allow the particular user device 12 to communicate with the system server 11 and/or with one or more advertisers' terminals 13.

Output from Step 5

The output from Step 5 includes a user's device 12 manipulation and/or a message from the user device 12, the system server 11 and/or from one or more advertisers' terminals 13.

Step 6—Establishing Advertiser-User Connection—See FIGS. 1 & 7

Step 6 includes establishing connection between the user and advertiser.

Activation

User choosing to communicate with a specific advertiser based on the EAPP

Main Functions

Establishing Advertiser-User Connection
Charging advertiser
   Establishing Advertiser-User Connection

When the user chooses to communicate with a specific advertiser, the system server 11 now establishes the connection.

Establishing the connection can be done in various ways, such as:
Invoking a communication system on the user's device 12 (e.g., VOIP system, Messenger, etc.)
Informing the advertiser of the user's communication device 12 and ID (e.g., Mobile telephone and the Telephone Number, specific VOIP software system and the User ID on that system, etc.)
Using an intermediation tool (such as telephone exchange, call-back system, etc.) to establish a conference (text/audio/video)

The user may also have the option to establish connection to more than one advertiser simultaneously.

Charging Advertiser

The system server 11 may charge the advertiser's account (prepaid or postpaid) upon the advertiser's selection by the user. This charge is triggered by the establishment of the User-Advertiser interaction

Output from Step 6

Connection between the User and an advertiser

Optional charge to the advertiser's account (prepaid or postpaid)

While various embodiments and individual features of the present invention have been illustrated and described, it would be obvious to those skilled in the art that various other changes and modifications can be made without departing from the spirit and scope of the present invention. As will also be apparent to those skilled in the art, various combinations of the embodiments and features taught in the foregoing description are possible and can result in preferred executions of the present invention. Accordingly, it is intended that such changes and modifications fall within the scope of the present invention as defined by the claims appended hereto.

### APPENDIX I

### Glossary

Communication network—Any type of network allowing communication between one, two or more participants, regardless of the platform and architecture or combination of platforms and architectures.
Communication network device—the device used to access the communication network, such as computer, phone, PDA, TV, a terminal or a mobile device.
A system operates in Real-time if it functions in a timeframe normal for person to person interaction over the appropriate medium such as internet and/or telephone.

What is claimed is:

1. A method of advertising to a potential customer who is using a computer connected to a network in which an ad from one or more registered advertisers each having an advertiser's terminal connected to said network can tailor an ad to said potential customer before said ad is presented to said potential customer; the method including:
providing a system server;
storing information relating to each of said one or more registered advertisers on a computer readable medium associated with said system server;
capturing information relating to said potential customer's use of said computer on said network;
employing at least some of said captured information and some or all of said information relating to said one or more registered advertisers to identify one or more of said registered advertisers as relevant advertisers for said potential customer;
informing one or more of said relevant advertisers, in real time, of said potential customer's activity whereby said one or more of said relevant advertisers can tailor an ad to said potential customer before said ad is presented to said potential customer;
receiving ads and/or other information relating to one or more of said relevant advertisers in response to said informing, said system server being used as an intermediary between said one or more relevant advertisers and said potential customer;
selecting one or more of said ads and/or other information relating to said one or more relevant advertisers for presentation to said potential customer after a waiting period; and
presenting said selected one or more of said ads and/or other information collected during said waiting period.

2. The method of claim 1, including said potential customer setting said waiting period.

3. The method of claim 2, including said potential customer setting said waiting period by selecting a predefined number of said selected one or more of said ads and/or other information for display in a group, said waiting period determined by the time required to select said predefined number in said selecting step.

4. The method of claim 2, said potential customer setting said waiting period to a predefined time interval.

5. The method of claim 1, said potential customer ending said waiting period by initiating an activity in real-time.

6. The method of claim 5, wherein said activity includes one of clicking on a button on a graphical user interface presented on said potential customer's computer, sending a manual request to said system server or directly to said one or more of said relevant advertisers, and providing a voice command to said one or more of said relevant advertisers.

7. A method, of advertising to a potential customer who is using a computer connected to a network in which an ad from one or more registered advertisers each having an advertiser's terminal connected to said network can tailor an ad to said potential customer before said ad is presented to said potential customer; the method including:
providing a system server;
storing information relating to each of said one or more registered advertisers on a computer readable medium associated with said system server;
capturing information relating to said potential customer's use of said computer on said network;
employing at least some of said captured information and some or all of said information relating to said one or more registered advertisers to identify one or more of said registered advertisers as relevant advertisers for said potential customer;
informing one or more of said relevant advertisers, in real time, of said potential customer's activity whereby said one or more of said relevant advertisers can tailor an ad to said potential customer before said ad is presented to said potential customer;
receiving ads and/or other information relating to one or more of said relevant advertisers in response to said informing, said system server being used as an intermediary between said one or more relevant advertisers and said potential customer;
selecting one or more of said ads and/or other information relating to said one or more relevant advertisers for presentation to said potential customer after a waiting period calculated in real-time according to a rule-based engine; and
presenting said selected one or more of said ads and/or other information collected during said waiting period.

8. The method of claim 7, wherein said presenting one or more of said ads and/or other information includes presenting a of said ads and/or other information after said waiting period, wherein said waiting period is measured by the time required to reach a pre-determined quota of said number of said ads and/or other information.

9. The method of claim 7, wherein said calculating said waiting period employs data from one or more of said captured information, a date and time of occurrence of said potential customer's activity, and parameters associated with the performance of said system server including one or more of load, performance, and priorities.

10. The method of claim 1, further comprising prioritizing said selected one or more of said ads and/or other information, said presenting step further including presenting said selected one or more of said ads and/or other information in the sequential order determined by said prioritizing step.

11. The method of claim 10, said presenting step including presenting one or more groups of said selected and prioritized one or more of said ads and/or other information according to the sequential order, and spaced by said waiting period.

12. The method of claim 10, said presenting step including presenting said selected and prioritized one or more of said ads and/or other information in the sequential order one at a time and spaced by said waiting period.

13. The method of claim 10, said prioritizing step comprising analyzing at least some of said ads and/or other information relating to said one or more of said relevant advertisers, information from said computer readable medium, and said captured information to prioritize the presentation of said selected one or more of said ads and/or other information in said presenting step according to one or more criteria.

14. The method of claim 13, wherein said criteria include at least one of time of creation, content, cost of presenting, relevancy to said captured information, history of each of said one or more relevant advertisers, a preference of each of said one or more of said relevant advertisers, and a preference of said potential customer.

15. The method of claim 1, wherein said presenting said selected one or more of said ads and/or other information includes displaying said selected one or more of said ads and/or other information as on-going visual media content.

16. The method of claim 15, wherein said on-going visual media content includes any combination of one or more of a graphic icon, a picture, a video clip, a snapshot of a website, descriptive text providing information about said relevant advertiser, a URL, a communication button providing a link to an internet communication service, a personalized response, and a visual indicator of a degree of relevance of said ad to said captured information.

17. The method of claim 16, wherein said descriptive text includes at least one of the name of said one or more of said relevant advertisers, a corresponding business name, a corresponding business category, a promotional description, an address, directions, a map, references and consumer feedback.

18. The method of claim 16, wherein said URL includes an internet link to one of a website, a coupon, a map, a satellite image, a video, and a webcam.

19. The method of claim 16, wherein said internet communication service includes one of Instant Messenger, a call service and a chat service accessible by clicking said communication button.

20. The method of claim 1, wherein said presenting step includes presenting said selected one or more of said ads and/or other information in audible form, wherein said audible form includes any combination of one or more of voice messages, sound effects, a personalized voice response, and an audible indicator of a degree of relevance of said ad to said captured information.

21. The method of claim 20, wherein said one or more of said voice messages includes a recitation of at least one of the name of said one or more of said relevant advertisers, a corresponding business name, a corresponding business category, a promotional description, an address, directions to said address, and consumer feedback.

22. A server-based system for advertising to a potential customer who is using a computer connected to a network in which an ad from one or more registered advertisers each having an advertiser's terminal connected to said network can tailor an ad to said potential customer before said ad is presented to said potential customer; said system including:
a system server connected to said network, said system server operably connected and in communication with said one or more registered advertiser's terminals and with said potential customer's computer through said network;
a computer readable storage medium operably connected with said system server comprising a database of stored information relating to each of said one or more registered advertisers, said computer readable storage medium adapted and configured to receive information from each of said one or more registered advertisers;
a network activity monitoring module operably connected and in communication with said system server for capturing information relating to said potential customer's network-based use of said computer; and
a software module residing on said system server and operably connected to said database, said software module configured to:
employ at least some of said captured information and some or all of said information relating to said one or more registered advertisers to identify one or more of said registered advertisers as relevant advertisers for said potential customer;
inform one or more of said relevant advertisers, in real time, of said potential customer's activity whereby said one or more of said relevant advertisers can tailor an ad to said potential customer before said ad is presented to said potential customer;
receive ads and/or other information relating to said potential customer' activity from said one or more of said relevant advertisers, said system server being used as an intermediary between said one or more of said relevant advertisers and said potential customer;
select one or more of said ads and/or other information relating to said one or more relevant advertisers for presentation to said potential customer after a waiting period; and
present said selected one or more of said ads and/or other information collected during said waiting period.

23. The system of claim 22, wherein said database includes records associated with each of said one or more registered advertisers, said records including at least one of an advertiser identifier, authenticating information, contact information, services provided, preferred opportunities, and payment information.

24. The system of claim 22, wherein said computer readable storage medium further includes a database for storing information associated with said potential customer.

25. The system of claim 22, wherein said network activity monitoring module is located and configured for capturing said information relating to said potential customer's network-based use of said computer associated with at least one of a directory net site, a search engine net server, an electronic bulletin board, and a user net device.

26. The system of claim 25, wherein said captured information and other information includes at least one of a location of and the device associated with said potential customer's computer.

27. The system of claim 22, said software module further configured to provide a data structure and to populate as many data elements as possible in said data structure with said captured information and other information to form a user activity outline relating to said potential customer and indicating the nature of said potential customer's activity.

28. The system of claim 27, said system further comprising an authenticating module for verifying said captured information.

29. The system of claim 22, said software module configured to set said waiting period in response to said potential customer setting said waiting period to a predefined time interval or ending said waiting period by initiating an activity in real-time.

30. The system of claim 22, wherein said waiting period is calculated in real-time according to a rule-based engine.

31. The system of claim 30, wherein said calculating said waiting period employs data from one or more of said captured information, a date and time of occurrence of said potential customer's activity, and parameters associated with the performance of said system server including one or more of load, performance, and priorities.

32. The system of claim 22, wherein said waiting period is measured by the time required to reach a pre-determined quota of said number of said ads and/or other information.

33. The system of claim 22, said software module further configured to prioritize said selected one or more of said ads and/or other information, and to present said selected one or more of said ads and/or other information in the prioritized order.

34. The system of claim 33, further comprising memory for temporarily storing said selected one or more of said ads and/or other information for presentation to said potential customer at the end of said waiting period, wherein said selected one or more of said ads and/or information include audio and/or visual media.

35. The system of claim 33, said software module further configured to analyze at least some of said ads and/or other information relating to said one or more of said relevant advertisers, information from said computer readable medium, and said captured information to determine said prioritized order according to one or more criteria.

36. The system of claim 35, wherein said criteria include at least one of time of creation, content, cost of presenting, relevancy to said captured information, history of each of said one or more relevant advertisers, a preference of each of said one or more of said relevant advertisers, and a preference of said potential customer.

37. The system of claim 22, wherein said potential user's computer comprises or is connected with a video display, said software module further configured to present said selected one or more of said ads and/or other information as on-going visual media content.

38. The system of claim 37, wherein said on-going visual media content includes any combination of one or more of a graphic icon, a picture, a video clip, a snapshot of a website, descriptive text providing information about said relevant advertiser, a URL, a communication button providing a link to an internet communication service, a personalized response, and a visual indicator of a degree of relevance of said ad to said captured information.

39. The system of claim 22, wherein said potential user's computer is connected to or comprises an audio device, wherein said software module is configured to present said selected one or more of said ads and/or other information in audible form, wherein said audible form includes any combination of one or more of voice messages, sound effects, a personalized voice response, and an audible indicator of a degree of relevance of said ad to said captured information.

40. The system of claim 39, wherein said one or more of said voice messages includes a recitation of at least one of the name of said one or more of said relevant advertisers, a corresponding business name, a corresponding business category, a promotional description, an address, directions to said address, and consumer feedback.
